(19) United States
(12) Patent Application Publication
(10) Pub. No.: US 2010/0254462 A1
(43) Pub. Date: Oct. 7, 2010

(54) METHOD FOR REDUCING MEMORY USAGE WITH ACCELERATED CHANNEL CHANGES

(75) Inventors: Eric Colin Friedrich, Medford, MA (US); Robert Andrew Drisko, Concord, MA (US); Joshua Bernard Gahm, Newtonville, MA (US); Atif Faheem, Nashua, NH (US)

Correspondence Address: MERCHANT & GOULD;SCIENTIFIC ATLANTA, A CISCO COMPANY, P.O. BOX 2903, MINNEAPOLIS, MN, 55402-0903, US

(73) Assignee: Cisco Technology, Inc., San Jose, CA (US)

(21) Appl. No.: 12/491,113

(22) Filed: Jun. 24, 2009

Related U.S. Application Data
(60) Provisional application No. 61/167,321, filed on Apr. 7, 2009.

(51) Int. Cl. H04N 11/02; H04L 12/56

(52) U.S. Cl. 375/240.25; 370/390; 375/E07.027

(57) ABSTRACT

Optimizations for rapid channel changes may be provided. In response to a channel change request, rate shaping may be used to provide a unicast packet stream at a first transmission rate for a first time interval before reducing the rate of the unicast packet stream to a lower transmission rate for a second time interval. During the second time interval, a multicast packet stream may be joined and the video frames associated with the unicast packet stream, which may lag behind the multicast packet stream, and the multicast packet stream may be synchronized.

### TECHNICAL FIELD

The present disclosure relates to digital signal distribution networks, and more particularly to channel change scenarios in digital television distribution systems.

### BACKGROUND

In television distribution systems, a set top box (STB) may receive a stream comprising audio and video data for presenting a corresponding program. Each of a plurality of program channels may have a corresponding data stream. For example, multiple data streams may be transmitted as Internet Protocol (IP) multicast streams over a distribution network to user terminals, with each channel sent to a separate multicast group. Data for each channel may be encoded in a format, such as Motion Picture Entertainment Group 2 (MPEG-2) or MPEG-4, in which intra-coded frames occur only at fixed maximum intervals in the stream, known in MPEG-2 as the Group Of Pictures (GOP) interval. In conventional systems, when a user desires to change channels, the STB needs to wait for one of these intra-coded frames before it can begin to display the new channel. This may negatively impact the user's experience by causing a delay in selecting different channels.

### BRIEF DESCRIPTION OF THE DRAWINGS

FIG. 1 is a block diagram of a programming distribution network;

FIG. 2 is a block diagram of a user terminal;

FIG. 3 is a flow chart of a method for optimizing rapid channel changes;

FIG. 4 is a plot depicting stages of the memory optimized rapid channel change process; and

FIG. 5 is a block diagram of a system including a computing device.

### DESCRIPTION OF EXAMPLE EMBODIMENTS

### Overview

Consistent with embodiments of the present invention, systems and methods are disclosed for memory optimizations for rapid channel change scenarios. Optimizations for rapid channel changes may be provided. In response to a channel change request, rate shaping may be used to provide a unicast packet stream at a first transmission rate for a first time interval before reducing the rate of the unicast packet stream to a lower transmission rate for a second time interval. During the second time interval, a multicast packet stream may be joined and the video frames associated with the unicast packet stream, which may lag behind the multicast packet stream, and the multicast packet stream may be synchronized.

It is to be understood that the foregoing overview and the following detailed description are explanatory only, and should not be considered to restrict the invention's scope, as described and claimed. Further, features and/or variations may be provided in addition to those set forth herein. For example, embodiments of the invention may be directed to various feature combinations and sub-combinations described in the detailed description.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Memory optimizations for a rapid channel change (RCC) may be provided. RCC optimizations may allow a user selecting a new channel to begin receiving and viewing a video stream for the new channel via a unicast packet stream from an RCC caching server rather than having to wait to join a multicast packet stream used to deliver the requested channel to multiple users. Consistent with embodiments of the invention, though not so limited, a primary video stream's data rate may be normalized to 1.

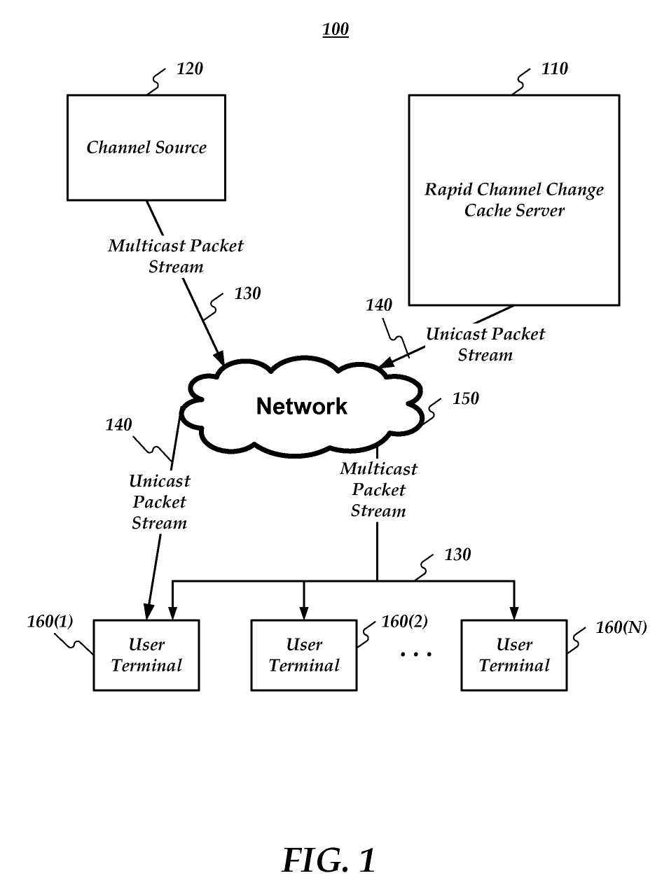

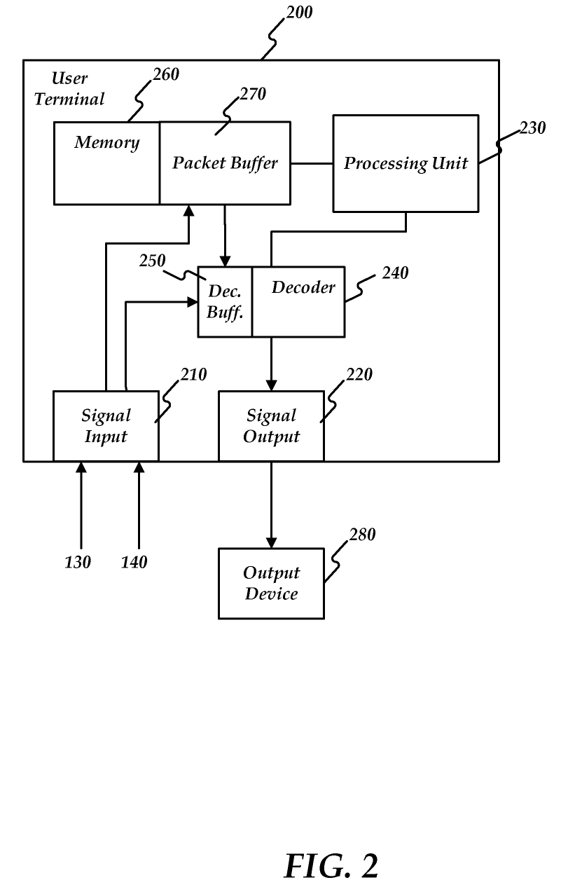

FIG. 1 is a block diagram of a distribution network 100 that may implement optimizations for rapid channel changes. For example, a user may select a new channel through user terminal. Distribution network 100 may comprise an RCC cache server 110 and a channel source 120 that may be operative to transmit packet streams over a network 150. Network 150 may comprise, for example, a dedicated programming data network and/or a shared network such as the Internet. Distribution network 100 may be operative to distribute programming channels and content to endpoints such as a plurality of user terminals 160(1)-160(N). For example, each user terminal 160(i) may comprise a set top box (STB) that may be connected to a television (not shown), a television device having STB functions integrated therein, a personal computer, a recording device such as a digital video recording, and/or another similar apparatus. A user terminal comprising, for example, STB 200 is described below in greater detail with respect to FIG. 2.

Channel source 120 may be operative to transmit a multicast packet stream 130 comprising channel programming to each user terminal 160(i). For each channel there may be a single programming (video) source, such as channel source 120, that sends the channel stream to a multicast group address. Any user terminal that may request the channel may join the multicast group, at which point distribution network 100 may arrange to have packets from multicast packet stream 130 delivered to the requesting user terminal.

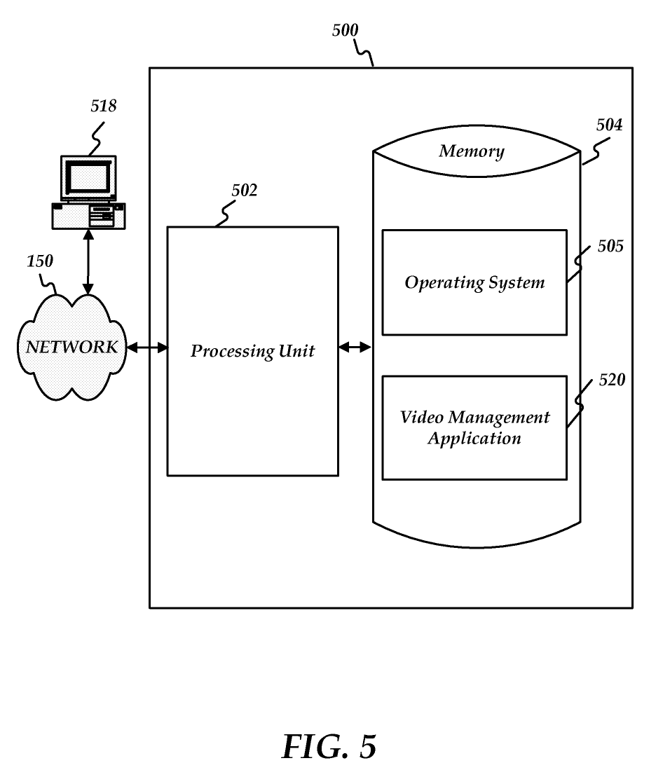

RCC cache server 110 may comprise a computing device 500 as described below with respect to FIG. 5. RCC cache server 110 may receive multicast packet stream 140 and may buffer packets associated with each of these streams for a time interval so that it can transmit the buffered packets associated with a particular channel to a user terminal when the user terminal makes a channel change request and until such time that the user terminal completes its joining of the multicast stream for the “new” channel contained in the channel change request.

Unicast packet stream 130 and multicast packet stream 140 may each comprise encoded video frames associated with a selected channel. Each frame of the video associated with the channel may be encoded into multiple data packets for transmission. For example, the encoded channel data may comprise 30 video frames per second, with each packet comprising a sequence number. Consistent with embodiments of the invention, the sequence number may be associated with one and/or multiple packets. Under the MPEG video encoding standard, frames may be associated with a group-of-pictures (GOP) comprising a number of frames corresponding to approximately half a second of video. Thus, a GOP may comprise 15 frames under the National Television System Committee (NTSC) standard while the Phase Alternating Line (PAL) standard, which uses 24 frames per second, may comprise 12 frames per GOP.

Consistent with embodiments of the invention, channel data cached by RCC cache server 110 for transmission in unicast packet stream 140 may lag behind channel data associated with the same requested channel being transmitted at the same time in multicast packet stream 130. For example, RCC cache server 110 may cache each packet of multicast packet stream 130 5 ms after the packet is transmitted by channel source 120.

FIG. 2 is a block diagram of user terminal 160(i) comprising STB 200. STB 200 may comprise a signal input component 210, a signal output component 220, a processing unit 230, a decoder 240 comprising a decoder buffer memory 250, and a system memory 260 comprising a packet buffer 270. STB 200 may be operative to receive programming data in the form of multicast packet stream 130 and/or unicast packet stream 140, decode, in decoder 240, video frames carried by the packet streams, and provide the decoded video frames to an output device 280. For example, output device 280 may comprise a television, a computing device, and/or a recording device.

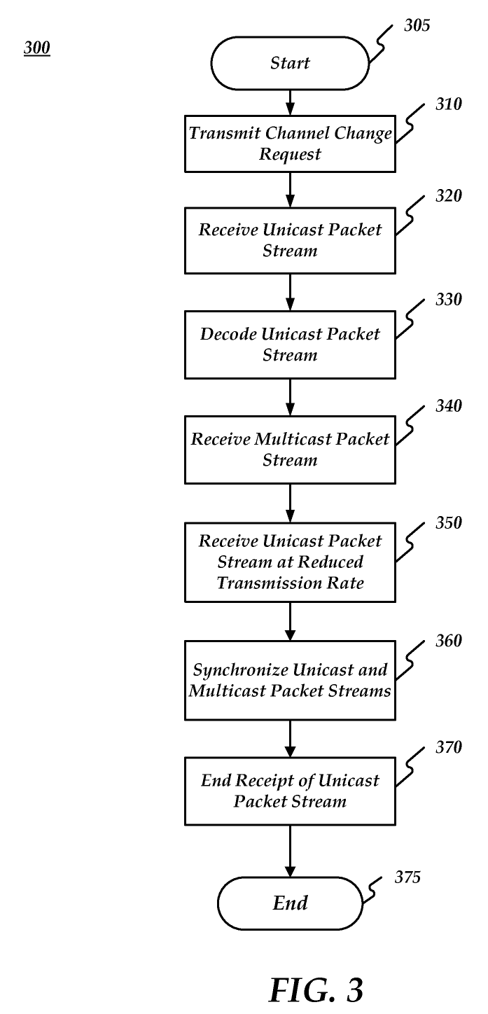

FIG. 3 is a flow chart of a method 300 for providing memory optimizations for rapid channel changes. Method 300 may be implemented using STB 200 as described above with respect to FIG. 2. Ways to implement the stages of method 300 will be described in greater detail below. Method 300 may begin at starting block 305 and proceed to stage 310 where STB 200 may transmit a channel change request. For example, user terminal 160(1) may receive a request from a user to select a new programming channel. The channel change request may be transmitted over network 150 and received by RCC cache server 110 and/or channel source 120. Consistent with embodiments of the invention, user terminal 160(1) may provide an available memory size of packet buffer 270 and decoder buffer 250 with the channel change request.

From stage 310, where STB 200 transmitted the channel change request, method 300 may advance to stage 320 where STB 200 may begin to receive a unicast packet stream comprising the requested channel stream. For example, user terminal 160(1) may receive unicast packet stream 140 from RCC cache server 110. Unicast packet stream 140 may comprise encoded sequential video streams cached by RCC cache server 110 from multicast packet stream 140.

Once STB 200 receives the unicast packet stream in stage 320, method 300 may continue to stage 330 where STB 200 may decode the received unicast packet stream. For example, user terminal 160(1) may send unicast packet stream 140 to decoder 240 to begin decoding the video information without buffering the data from unicast packet stream 140 in packet buffer 270.

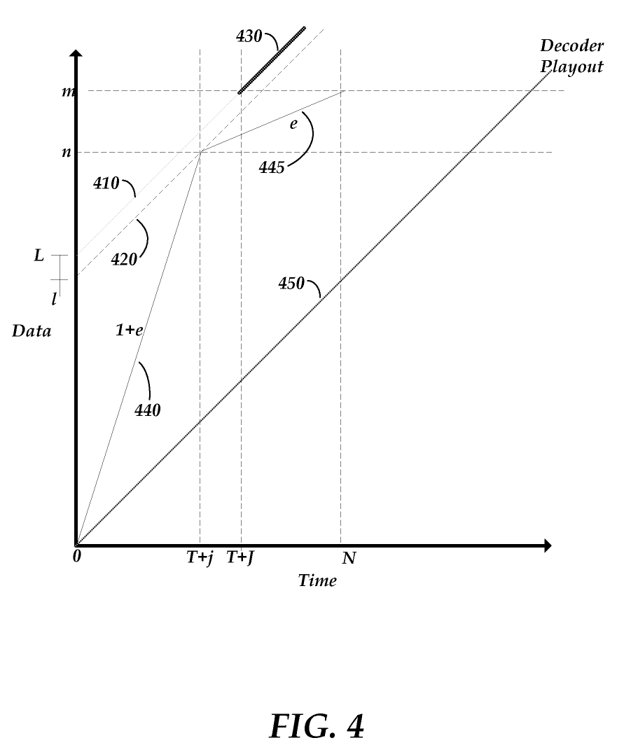

Once STB 200 receives the unicast packet stream in stage 320, method 300 may continue to stage 330 where STB 200 may decode the received unicast packet stream. For example, user terminal 160(1) may send unicast packet stream 140 to decoder 240 to begin decoding the video information without buffering the data from unicast packet stream 140 in packet buffer 270. User terminal 160(1) may begin playing out the decode video to output device 280 at a primary stream rate “1” while receiving packets from unicast packet stream 140 at a transmission rate of 1+e, where e comprises a computed transmission rate factor. The computation of e is discussed below in greater detail with respect to FIG. 4. Thus, video frames from unicast packet stream 140 may be received and decoded before they are played out and may be stored in decoder buffer 250 until needed for playback.

Once STB 200 decodes the unicast packet stream in stage 330, method 300 may continue to stage 340 where STB 200 may receive a multicast packet stream. For example, user terminal 160(1) may join multicast packet stream 130 after a time interval from the time user terminal 160(1) began receiving unicast packet stream 140. Consistent with embodiments of the invention, the predetermined time interval may comprise a delay in joining multicast packet stream 140 until a number of packets associated with the requested channel cached by RCC cache server 110 have been transmitted to and/or received by user terminal 160(1). For example, RCC cache server 110 may comprise a sequential series of packets from a time comprising an age of a first packet to be transmitted in unicast packet stream 130 to a time comprising the aforementioned lag in the RCC cache behind multicast packet stream 140. Thus, the first packet of unicast packet stream 140 may be 2000 ms old. Unicast packet stream may comprise a transmission of cached sequential packets from a time 2000 ms in the past up to a time 5 ms behind a current packet of multicast packet stream 130. The time interval may thus be determined as the time required to transmit the cached sequential packets at the 1+e transmission rate. User terminal 160(1) may then join multicast packet stream 140 and begin receiving multicast packets at transmission rate 1.

Once STB 200 receives the multicast packet stream in stage 340, method 300 may continue to stage 350 where STB 200 may receive the unicast packet stream at a reduced transmission rate. For example, user terminal 160(1) may receive unicast packet stream 140 at a transmission rate of e. Thus, throughout an RCC burst transmission of packets, user terminal 160(1) may receive packets at a rate of 1+e. During a first leg of the RCC burst, packets are received at transmission rate 1+e from unicast packet stream 140, while during a second leg, packets may be received from multicast packet stream 130 at a transmission rate of 1 and simultaneously may be received from unicast packet stream 140 at a transmission rate of e.

Once STB 200 receives the unicast packet stream at the reduced transmission rate e in stage 350, method 300 may continue to stage 360 where STB 200 may synchronize the unicast packet stream and the multicast packet stream. For example, user terminal 160(1) may buffer packets received from multicast packet stream 130 in packet buffer 270 until a packet received from unicast packet stream 140 comprises a prior packet, sequentially, in the packet sequence associated with the requested channel. By minimizing the time needed to synchronize the unicast and multicast packet streams, as by transmitting unicast packet stream 140 at a high value for the transmission rate e, for example, memory requirements to perform the RCC process for STB 200 may be reduced.

Once STB 200 synchronizes the unicast and multicast packet streams in stage 360, method 300 may advance to stage 370 where STB 200 may stop receiving the unicast packet stream. For example, once unicast packet stream 140 has caught up to the first packet received by user terminal 160(1) from multicast packet stream 130, unicast packet stream 140 may cease transmission. Consistent with embodiments of the invention, user terminal 160(1) may continue to receive unicast packets after unicast packet stream 140 has caught up to the packets received from multicast packet stream 130 and may use packets received from unicast packet stream 140 to perform error correction on packets received from multicast packet stream 130. Once STB 200 ends receipt of the unicast packet stream in stage 370, method 300 may then end at stage 375.

FIG. 4 is a plot 400 depicting stages of the memory optimized rapid channel change process. Plot 400 comprises the following variables and abbreviations: “m” comprises a first multicast sequence number received by user terminal 160(i); “n” comprises a last sequence number in the first leg of an RCC burst transmission; “L” comprises an age of the first packet of unicast packet stream 140; “I” comprises a lag of RCC cached packets behind multicast packet stream 130; “T+j” comprises an earliest time for user terminal 160(i) to join multicast packet stream 130; “T+J” comprises a latest time for user terminal 160(i) to join multicast packet stream 130; “N” comprises a completion time of the RCC burst transmission; and e comprises a transmission rate. The X-axis of plot 400 comprises time and the y-axis of plot 400 comprises an amount of transmitted data. The preceding variables may be further defined by the equations:

$$\begin{matrix}m = T + J + L & Equation 1 \\ e = \frac{m - n}{N - ( T + j )} & Equation 2 \\ n = ( T + j ) ( 1 + e ) & Equation 3\end{matrix}$$

The difference between T+j and T+J comprises ΔJ, a difference between the earliest time user terminal 160(i) may join multicast packet stream 130 and the latest time user terminal 160(i) may join multicast packet stream 130. Plot 400 comprises a primary multicast data line 410, an RCC cache data line 420, a client-received multicast data line 430, a first leg of an RCC unicast burst line 440, a second leg of the RCC unicast burst line 445, and a decoded video playback line 450. Consistent with embodiments of the invention, primary multicast data line 410 and decoded video playback line 450 may comprise the normalized time/data rate 1. That is, video frames on multicast packet stream 130 may be received at a 1:1 ratio with the playback rate of user terminal 160(i).

To minimize an amount of memory buffering needed on user terminal 160(i), the amount of multicast data buffered may be minimized by minimizing the time interval of the second leg of the RCC burst transmission, when unicast packet stream 140 is transmitted at rate e. This time interval may be minimized when the multicast join is delayed until the first leg of the unicast burst reaches the last packet of RCC cache server 110's cache for the requested channel. As shown by first leg of an RCC unicast burst line 440, the first leg of unicast packet stream 140 may be transmitted at a rate of 1+e for a first time interval comprising time 0 to time T+j, where time 0 comprises a time when user terminal 160(i) receives the first packet from unicast packet stream 140. As shown by second leg of the RCC unicast burst line 445, the second leg of unicast packet stream 140 may be transmitted at a rate of e for a second time interval comprising the time T+j to time N.

Time N, the total duration of the RCC burst transmission, may be computed as follows:

$$\begin{matrix}e = \frac{T + J + L - ( T + j ) ( 1 + e )}{N - ( T + j )} & Equation 4 \\ e = \frac{( J - j ) + L - e ( T + j )}{N - ( T + j )} & Equation 5 \\ N = \frac{( J - j ) + L}{e} & Equation 6\end{matrix}$$

From the above equations and plot 400, time T+j, the time at which user terminal 160(i) may join multicast packet stream 130, may be determined according to the equations:

$$\begin{matrix}1 + e = \frac{n}{T + j} = \frac{( L - l ) + ( T + j )}{T + j} & Equation 7 \\ T + j = \frac{L - l}{e} & Equation 8\end{matrix}$$

The age of the first packet of unicast packet stream 140 may be computed by computing a smallest feasible L value. L may be minimized when user terminal 160(i) consumes all RCC burst data just as the burst ends, creating a borderline underflow condition. That is, the last packet of unicast packet stream 140 may comprise a packet prior in sequence to the first packet of multicast packet stream 130 received by user terminal 160(i). This may be shown on plot 400 by shaping the RCC transmission burst such that the end point of the second leg of unicast RCC burst occurs at point (N, m).

The amount of buffer memory 270 needed for the RCC burst transmission may be decreased by STB 200 fast filling decoder 240. Consistent with embodiments of the invention, the fast-filled data may be pushed into decoder 240 and may come from unicast packet stream 140 and/or multicast packet stream 130. Data from unicast packet stream 140 may also be used to provide backfill data for user terminal 160(i). The data may be pushed into decoder 240 in sequential order as quickly as it is received. A small amount of memory, such as packet buffer 270, may be used to buffer the multicast data while waiting for the gap to be filled by the second (rate e) segment of the RCC burst transmission. Once this gap fills, user terminal 160(i) may resume pushing data to decoder 240 with the first packet of multicast packet stream 130.

User terminal 160(i) may receive data indicating the actual amount of backfill to be stored in packet buffer 270 at the time user terminal 160(i) joins multicast packet stream 130 during the RCC burst transmission. Consistent with embodiments of the invention, the quantity of data to be fast filled may be determined, by the packet stream decoder, for example, according to at least one of the following equations:

fastfill_quantity=dt_earliest_join*(1−(maximum_backfill/actual_fill_at_join) Equation 9

fastfill_quantity=(actual_backfill−maximum_backfill)*(1+(dt_earliest_join/actual_fill_at_join))+actual_fastfill Equation 10

Thus, excess data sent in the RCC burst transmission above the amount that user terminal 160(i) may store in packet buffer 270 may be stored instead in decoder buffer 250. The value maximum_backfill in Equation 9 above may be the value of a maximum backfill value sent from RCC cache server 110 to user terminal 160(i). User terminal 160(i) may provide a maximum_fastfill time to RCC cache server 110. This value may be given in milliseconds and may represent the size of decoder buffer 250 in stream time. The maximum_fastfill field may, when non-zero, indicate user terminal 160(i) is capable of (and desires) receiving data for fast fill. Maximum_fastfill may also bound the amount of data pushed into decoder buffer 250. If, for example, the fastfill_quantity is larger than maximum_fastfill, RCC cache server 110 may not send the RCC burst transmission. For another example, if fastfill_quantity is larger than maximum_fastfill, user terminal 160(i) may buffer packets received from unicast packet stream 140 in packet buffer 270. The actual_backfill value may comprise an amount of video data present in decoder buffer memory 250 and/or packet buffer 270 at the completion of the rapid channel change burst. The actual_fastfill value may comprise an amount of video data sent at a rate of 1+e for the purpose of further accelerating a channel change.

An example use case may comprise the following data.

TABLE 1

| Name | Symbol | Value |
|---|---|---|
| GOP Size | G | 2 s |
| IGMP Join | ΔJ | 100 ms |
| Latency | | |
| e-Factor | e | 2. & .95 |
| Multicast Lag | l | 15 ms |
| Stream Rate | r | 4 Mbps (SD) & 15 Mbps (HD) |

Using the values of table 1 and applied to the equations and methods described above, the following results may be computed for RCC burst transmission with e values set at 0.2 (Table 2) and 0.95 (Table 3). Consistent with embodiments of the invention, e may be a configurable value set by RCC Cache server 110 and/or user terminal 160(i). The value of e may be computed according to at least one of the age of a first packet of the unicast packet stream (L), a multicast join latency (ΔJ), a cache size associated with the unicast packet stream, and an available bandwidth.

TABLE 2
e = 0.2

| Name | Memory Optimized |
|---|---|
| First Packet Age (L) | 1475 ms |
| IGMP Join (T + j) | 7300 ms |
| Length of Second Leg | 575 ms |
| Burst Length (N) | 7875 ms |

TABLE 3
e = 0.95

| Name | Memory Optimized |
|---|---|
| First Packet Age (L) | 1021.05 ms |
| IGMP Join (T + j) | 1059 ms |
| Length of Second Leg | 121 ms |
| Burst Length (N) | 1180 ms |

Both RCC transmission bursts provide the same amount of actual_backfill, which is equal to the age of the first packet (L). User terminal 160(i) may share buffer memory between decoder buffer 250 and packet buffer 270 and the fast fill may decrease the memory requirements of user terminal 160(i) by playing data received from unicast packet stream 140 into decoder 240 as soon as they are received rather than buffering the unicast packets in packet buffer 270. Consistent with embodiments of the invention, packets may be reordered prior to being sent to decoder buffer 250.

Multicast packet stream 130 may be buffered, in packet buffer 270, for example, pending the completion of unicast packet stream 140 at the end of the second leg of the transmission burst. Thus, user terminal 160(i) may only need enough memory to buffer multicast packet stream 130 for the entire second leg of the burst. For a video stream at 4 Mbps, this may save 4 Mb (500 KB) of memory or 15 Mb for a High Definition (HD) 15 Mbps stream. This may comprise 331 packets at 4 Mbps and 1243 packets at 15 Mbps.

An embodiment consistent with the invention may comprise a system for providing optimized rapid channel changes. The system may comprise a memory storage and a processing unit coupled to the memory storage. The processing unit may be operative to transmit a channel change request, receive and decode a unicast packet stream associated with the requested channel at a first transmission rate for a first time interval, receive a multicast packet stream associated with the requested channel at a second transmission rate, and receive the unicast packet stream at a third transmission rate for a second time interval.

Another embodiment consistent with the invention may comprise a system for providing rapid channel changes. The system may comprise a memory storage, a packet stream decoder, and a processing unit coupled to the memory storage and the packet stream decoder. The packet stream decoder may be operative to receive and decode a data packet comprising an encoded video frame and output the video frame. The processing unit may be operative to transmit a channel change request, receive a unicast packet stream at a first transmission rate for a first time interval, provide the unicast packet stream to the packet stream decoder, receive the unicast packet stream at a second transmission rate for a second time interval, and receive a multicast packet stream at a third transmission rate.

Yet another embodiment consistent with the invention may comprise a system for providing memory-optimized rapid channel changes. The system may comprise a memory storage and a processing unit coupled to the memory storage. The processing unit may be operative to transmit a channel change request comprising a backfill buffer size, receive a unicast packet stream at a first rate for a first time interval, decode video frames for output. The processing unit may be further operative to receive the unicast packet stream at a second rate for a second time interval after the first time interval, receive a multicast packet stream, and buffer the multicast packet stream. Encoded video frames received from the unicast packet stream and the multicast packet stream may be decoded by a hardware decoding device.

With reference to FIG. 5, a system consistent with an embodiment of the invention may include a computing device, such as computing device 500. In a basic configuration, computing device 500 may include at least one processing unit 502 and a system memory 504. Depending on the configuration and type of computing device, system memory 504 may comprise, but is not limited to, volatile (e.g. random access memory (RAM)), non-volatile (e.g. read-only memory (ROM)), flash memory, or any combination. System memory 504 may include operating system 505 and at least one programming modules, such as a video management application 520. An example of video management application 520 may comprise the Visual Quality Experience family of products produced by Cisco® Technology, Inc. of San Jose, Calif. Operating system 505, for example, may be suitable for controlling computing device 500's operation. In one embodiment, the programming modules may include a video caching application. Furthermore, embodiments of the invention may be practiced in conjunction with a graphics library, other operating systems, or any other application program and is not limited to any particular application or system.

Computing device 500 may have additional features or functionality. For example, computing device 500 may also include additional data storage devices (removable and/or non-removable) such as, for example, magnetic disks, optical disks, or tape. Computer storage media may include volatile and nonvolatile, removable and non-removable media implemented in any method or technology for storage of information, such as computer readable instructions, data structures, program modules, or other data. System memory 504, the removable storage, and the non-removable storage are all computer storage media examples (i.e memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 500. Any such computer storage media may be part of device 500. Computing device 500 may also have input device(s) such as a keyboard, a mouse, a pen, a sound input device, a touch input device, etc. Output device(s) such as a display, speakers, a printer, etc. may also be included. The aforementioned devices are examples and others may be used.

Computing device 500 may also contain a communication connection that may allow device 500 to communicate with other computing devices 518, such as over network 150 in a distributed computing environment, for example, an intranet or the Internet. The communication connection is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 504, including operating system 505. While executing on processing unit 502, programming modules (e.g. video management application 520) may perform processes including, for example, one or more of method 300's stages as described above. The aforementioned process is an example, and processing unit 502 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for optimizing rapid channel changes comprising:
transmitting a channel change request comprising a memory buffer size associated with a decoding device;
in response to the channel change request, receiving a unicast packet stream associated with the requested channel at a first transmission rate for a first time interval;
decoding, by the decoding device, the requested channel from the unicast packet stream;
receiving a multicast packet stream associated with the requested channel at a second transmission rate, wherein receipt of the multicast packet stream begins at the end of the first time interval; and
receiving the unicast packet stream at a third transmission rate for a second time interval, wherein receipt of the unicast packet stream at the third transmission rate begins at the end of the first time interval.

2. The method of claim 1, wherein the first time interval comprises an interval between a receipt of a first packet of the unicast packet stream and an earliest time when the multicast packet stream can be joined.

3. The method of claim 1, wherein the first transmission rate comprises a transmission rate equal to the sum of the second transmission rate and the third transmission rate.

4. The method of claim 1, wherein the unicast packet stream and the multicast packet stream each comprise a plurality of encoded frames comprising audio and video data.

5. The method of claim 5, wherein the second transmission rate comprises a playback rate of the plurality of encoded frames.

6. The method of claim 1, wherein the unicast packet stream is received from a first content server and the multicast packet stream is received from a second content server.

7. The method of claim 8, further comprising:
computing the first time interval according to the provided memory buffer size.

8. The method of claim 1, further comprising:
computing an earliest time when the multicast packet stream can be joined, wherein the earliest time when the multicast packet stream can be joined comprises the end of the first time interval;
computing a latest time when the multicast packet stream can be joined; and
buffering at least one packet of the multicast packet stream after the computed latest time when the multicast packet stream can be joined.

9. The method of claim 1, wherein a first received packet of the multicast packet stream comprises a sequentially later packet of the requested channel than has been received from the unicast packet stream.

10. The method of claim 8, wherein the unicast packet stream transmission continues to be received at least until the unicast packet stream has caught up to the sequentially later packet received from the multicast packet stream.

11. An apparatus for providing rapid channel changes, the apparatus comprising:
a memory;
a packet stream decoder coupled to the memory, wherein the packet stream decoder is operative to:
receive a data packet comprising a video frame,
decode the video frame, and
output the video frame; and
a processing unit coupled to the memory and the packet stream decoder, wherein the processing unit is operative to:
transmit a channel change request, wherein the channel change request comprises an amount of memory available as a channel data buffer,
receive a unicast packet stream at a first transmission rate for a first time interval, wherein the unicast packet stream comprises a first plurality of video frames associated with the requested channel,
provide the unicast packet stream to the packet stream decoder,
receive the unicast packet stream at a second transmission rate for a second time interval, and
receive a multicast packet stream at a third transmission rate, wherein the multicast packet stream comprises a second plurality of video frames associated with the requested channel and wherein a first packet of the multicast packet stream is received during the second time interval.

12. The system of claim 11, wherein the second plurality of video frames associated with the multicast packet stream comprises sequentially later frames of the requested channel than the first plurality of video frames associated with the unicast packet stream.

13. The system of claim 12, wherein the second time interval comprises an amount of time computed to receive at least one packet from the unicast packet stream that sequentially overlaps with the first packet received from the multicast packet stream.

14. The system of claim 11, wherein the unicast packet stream ends after the second time interval.

15. The system of claim 11, wherein the unicast packet stream is received from a first content server and the multicast packet stream is received from a second content server.

16. The system of claim 11, wherein the first transmission rate comprises the sum of a playback rate associated with the multicast packet stream and the second transmission rate.

17. The system of claim 16, wherein the second transmission rate is computed according to at least one of the following factors: an age of a first packet of the unicast packet stream, a multicast join latency, a cache size associated with the unicast packet stream, and an available bandwidth.

18. A computer-readable medium which stores a set of instructions which when executed performs a method for providing memory-optimized rapid channel changes, the method executed by the set of instructions comprising:
transmitting a channel change request comprising a backfill buffer size;
receiving a unicast packet stream comprising a first plurality of video frames associated with the requested channel at a first rate for a first time interval;
decoding, by a decoding device, the first plurality of video frames for output;
receiving the unicast packet stream comprising a second plurality of video frames associated with the requested channel at a second rate for a second time interval after the first time interval;
receiving a multicast packet stream comprising a third plurality of video frames associated with the requested channel, wherein a first packet of the multicast packet stream is received during the second time interval; and
buffering the multicast packet stream.

19. The computer-readable medium of claim 18, further comprising:
at the end of the second time interval, decoding, by the decoding device, the third plurality of video frames for output after the end of the second time interval.

20. The computer-readable medium of claim 18, further comprising:
receiving the unicast packet stream comprising the second plurality of video frames until the second plurality of video frames has sequentially caught up with the third plurality of video frames received from the multicast packet stream.
